(19) United States
(12) Patent Application Publication
(10) Pub. No.: US 2020/0050149 A1
(43) Pub. Date: Feb. 13, 2020

(54) PINION COMPONENT WITH CONDUCTIVE PATHS

(71) Applicant: Hewlett-Packard Development Company, L.P., Spring, TX (US)

(72) Inventors: Brian Spate, Houston, TX (US); Michael W. Hu, Vancouver, WA (US); Shawn Richard Piper, Vancouver, WA (US); Juli Unger, Vancouver, WA (US)

(73) Assignee: Hewlett-Packard Development Company, L.P., Spring, TX (US)

(21) Appl. No.: 16/343,099

(22) PCT Filed: Oct. 21, 2016
(86) PCT No.: PCT/US2016/058271

§ 371 Date: Apr. 18, 2019

(51) Int. Cl. G04B 13/02; F16H 1/06

(52) U.S. Cl. CPC G04B 13/026; G04B 99/00; G04B 13/022; F16H 1/06

(57) ABSTRACT

An example apparatus includes a first pinion component comprising a first pinion and a first cylinder centered therein, the first cylinder extending from a first surface of the first pinion, the first pinion having a first via and a second via; a first electrical path extending from a second surface of the first pinion, through the first via to the first surface of the first pinion, and further to a first surface portion of the first cylinder; a second electrical path extending from the second surface of the first pinion, through the second via to the first surface of the first pinion, and further to a second surface portion of the first cylinder, wherein the second electrical path is electrically isolated from the first electrical path.

### BACKGROUND

In conventional timepieces, the hands are attached to a pin that is rotated by a mechanical or motorized movement beneath the dial. The hands may be coated with a luminous material that causes the hands to glow passively in low light conditions.

### BRIEF DESCRIPTION OF THE DRAWINGS

For a more complete understanding of various examples, reference is now made to the following description taken in connection with the accompanying drawings in which:

FIG. 1 is a perspective illustration of an example pinion component with isolated conductive paths from a first perspective;

FIG. 2 is a perspective illustration of the example pinion component of FIG. 1 from a second perspective;

FIG. 3 illustrates an example device including example pinion component;

FIG. 4 is a top view of an example watch hand assembly;

FIG. 5 is a side view of the example watch hand assembly;

FIG. 6 is a perspective illustration of two examples of a pinion component;

FIG. 7 is a second perspective illustration of the two examples of a pinion component;

FIG. 8 is top view of an assembly of two examples of a pinion component;

FIG. 9 is a sectional view of the assembly of the two examples of a pinion component of FIG. 8;

FIG. 10 is a bottom view of the assembly of the two examples of a pinion component of FIG. 8; and

FIG. 11 is a perspective illustration of an electrical interface to an example of a pinion component;

FIG. 12 is a perspective illustration of an electrical interface to another example of a pinion component;

FIG. 13 is a flowchart illustrating an example process for manufacturing a pinion component with isolated conductive paths.

### DETAILED DESCRIPTION

The present disclosure describes examples of pinion components, for example, for timepieces and other applications, to provide electrical power and/or signals to electrical components and/or assemblies attached to the pinion component.

In various examples, a pinion component is provided with a non-conductive pinion and a non-conductive hollow cylinder in the center of the pinion. In one example, one end of the cylinder may extend above a first surface of the pinion and the other end of the cylinder may be flush with a second surface of the pinion. The pinion may have a first via at a first distance from the center of the pinion and a second via at a second distance from the center of the pinion. In one example, a first conductive coating provides a first electrical path on the second surface of the pinion, through the first via to the first surface of the pinion, continuing to the cylinder and to a first surface portion of the cylinder. A second conductive coating may provide a second electrical path on the second surface of the pinion, electrically isolated from the first electrical path, through the second via to the first surface of the pinion and continuing to the cylinder and to a second surface portion of the cylinder.

As described in further detail below, the configuration of the conductive paths on the pinion component may provide for the application of electrical power and/or signals to an electrical component, such as a component mounted on a hand of a timepiece that is attached to the cylinder, and which rotates with the cylinder as the pinion rotates.

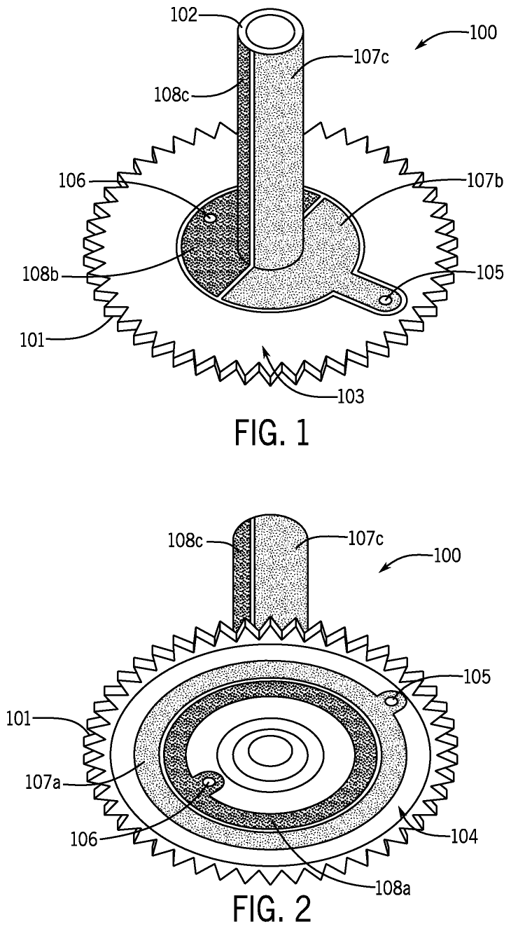

Referring now to the figures, FIGS. 1 and 2 illustrate, respectively, top and bottom views of an example pinion component 100. Pinion component 100 includes a pinion 101 and a cylinder 102. In various examples, the cylinder 102 may be a hollow cylinder, as illustrated in the example of FIG. 1. Pinion 101 and cylinder 102 may be formed as a single piece of material or assembled from separate pieces. Pinion 101 has a first surface 103 (shown in FIG. 1) and a second surface 104 (shown in FIG. 2). The underlying material(s) for pinion 101 and cylinder 102 are electrically non-conductive (e.g., plastic, ceramic or other suitable material). The surfaces of pinion 101 and cylinder 102 are initially coated with an electrically conductive coating which is selectively removed (e.g., by chemical etching or laser ablation) to create electrically conductive paths as described below.

FIGS. 1 and 2 illustrate, respectively, top and bottom views of the pinion component 100 after the selective removal of the conductive material and formation of vias 105 and 106. In various examples, the vias can be formed (e.g., drilled) before the pinion component is coated with the conductive material, such that when the conductive material is applied, the vias automatically provide a connection between the first surface 103 and the second surface 104. In the example where the vias are drilled after the conductive material is applied, electrical connection between the first surface 103 and the second surface 104 may be provided, for example, by solder filling, wiring, electrolysis plating (or electroplating) or other suitable method.

As illustrated in FIGS. 1 and 2, an example first electrical path includes an outer ring 107a of conductive material on the second surface 104, via 105, a conductor 107b of conductive material on the first surface 103, and a conductor 107c on a surface portion of the cylinder 102. Also illustrated in FIGS. 1 and 2 is an example of a second electrical path that includes an inner ring 108a of conductive material on the second surface 104, via 106, a conductor 108b on surface 104, and a conductor 108c on a separate surface portion of cylinder 102. In the example of FIGS. 1 and 2, the inner ring 108a is concentric with the outer ring 107a. It will be appreciated the conductor patterns illustrated in FIGS. 1 and 2 are only examples. In particular, the conductor patterns 107b and 108c on the first surface 103 and the conductor patterns 107c and 108c on cylinder 102 can be varied significantly for any application.

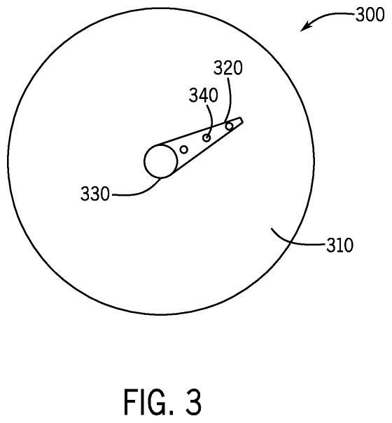

Referring now to FIG. 3, an example device including example pinion component is illustrated. In the example illustrated in FIG. 3, the example device 300 is a timepiece, such as a stopwatch, for example. The example device 300 of FIG. 3 is provided with a watch face 310 on which various indicia may be printed. For example, the watch face 310 may include indicia to facilitate display of time. Additional indicia may include the name of the manufacturer, for example.

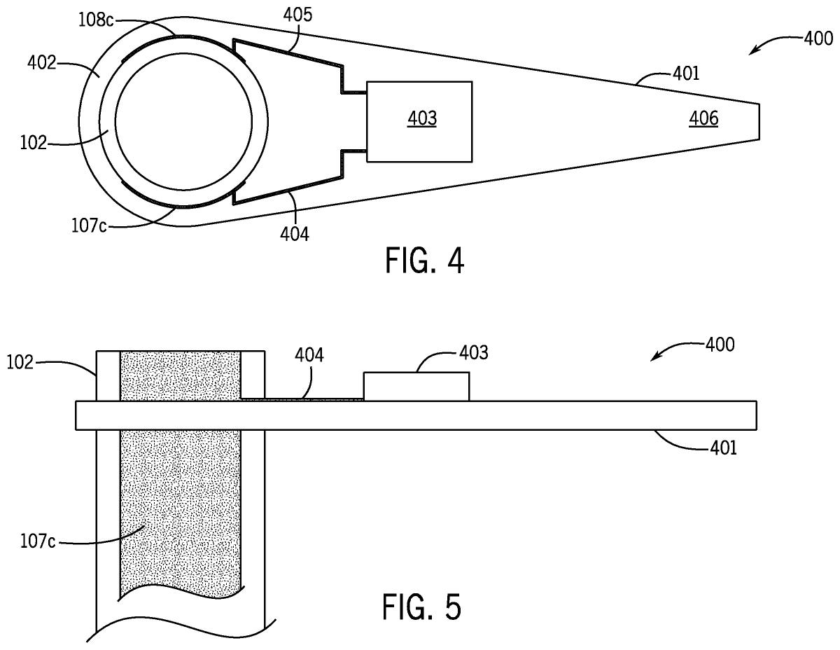

The example device 300 is provided with a hand 320 which may rotate with a pinion component 330. Various electrical components 340 may be provided on the hand 320 of the example device 300. The electrical components 340 may include, for example, light-emitting diodes, liquid crystal displays or any of a variety of electrical components that may be positioned on the surface of the hands. Electrical signals for data or power may be delivered to the electrical components 340 through the pinion component 330, which may be similar to the pinion component 100 described above with reference to FIGS. 1 and 2, and as described in the examples below with reference to FIGS. 4 and 5.

FIGS. 4 and 5 illustrate, respectively, a top view and a side view of an assembly 400 of an example cylinder 102 (similar to the cylinder 102 described above with reference to FIGS. 1 and 2) and an example watch hand 401 fixed to cylinder 102. As described above with reference to FIGS. 1 and 2, the cylinder 102 is coupled to the pinion 101 to form the example pinion component 100. As illustrated in FIGS. 4 and 5, watch hand 401 may be a flat, elongated member with an annular end portion 402 configured to engage cylinder 102 and be fixed with cylinder 102. As further illustrated in FIGS. 4 and 5, an electrical component 403 may be mounted to a planar surface 406 of watch hand 401. Examples of electrical component 403 may include, without limitation, an LED, an electroluminescent material, or any type of sensor. Planar surface 406 may be a non-conductive surface with printed conductors 404 and 405 to provide, respectively, electrical connectivity from conductor 107c and conductor 108c to electrical component 403. In other examples, and without limitation, the electrical connections between electrical component 403 and conductors 107c and 108c may be provided by wired connections or some combination of wired and printed connections.

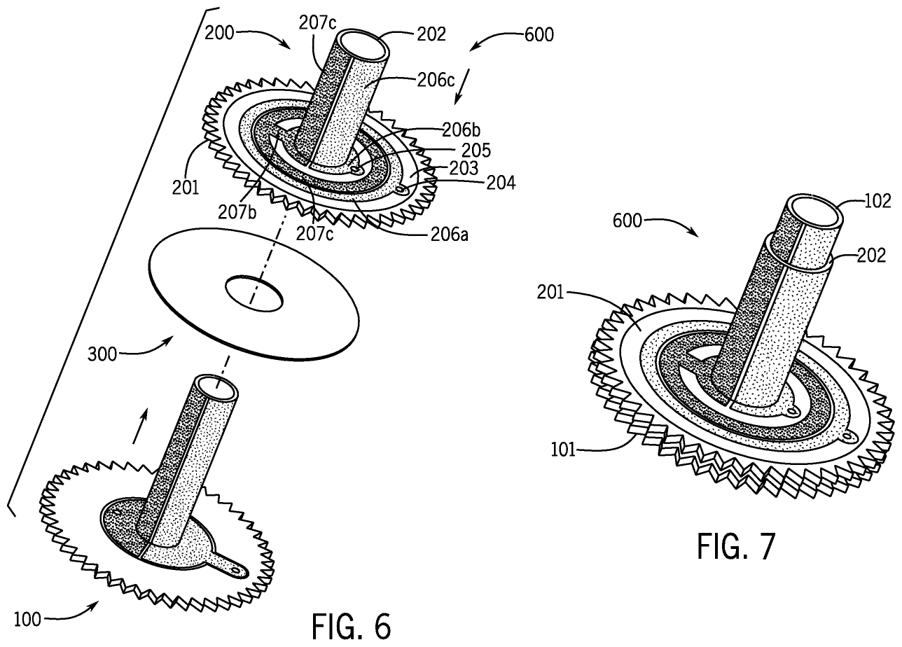

Referring now to FIGS. 6 and 7, an assembly is formed using the example pinion component 100 described above and a second example pinion component 200. Similar to pinion component 100, pinion component 200 includes a second pinion 201 made of non-conductive material and a second cylinder 202 made of non-conductive material centered therein. Second cylinder 202 extends above a first surface 203 of second pinion 201. Second pinion 201 has a third via 204 at a first distance from the center of second pinion 201 and a fourth via 205 at a second distance from the center of second pinion 201.

As illustrated in FIG. 6, the second pinion component 200 also has conductive material defining two electrical paths. For example, one electrical path includes an outer ring 206a on the first surface 203, a connection between via 204 and via 205 on the underside of pinion 201 (not shown), a conductor 206b on the first surface 203 from via 205 to cylinder 202, and a conductor 206c on a surface portion of cylinder 202. Also illustrated in FIG. 6 is another electrical path that includes an inner ring 207a on the first surface 203 concentric with the outer ring 206a, a conductor 207b from ring 207a to cylinder 202, and a conductor 207c on a separate surface portion of cylinder 202.

FIG. 6 illustrates the assembly 600 which includes an instance of pinion component 100 arrayed beneath pinion component 200 to illustrate their respective dimensions. In one example, the inner diameter of cylinder 202 is larger than the outer diameter of cylinder 102. This relationship allows for cylinder 102 to be inserted through cylinder 202 as illustrated in FIG. 7. Additionally, a spacer component 300 may be provided between the pinion component 100 and the second pinion component 200 to prevent shorting of the various conductive paths. The spacer component 300 is formed of an insulating (non-conductive) material.

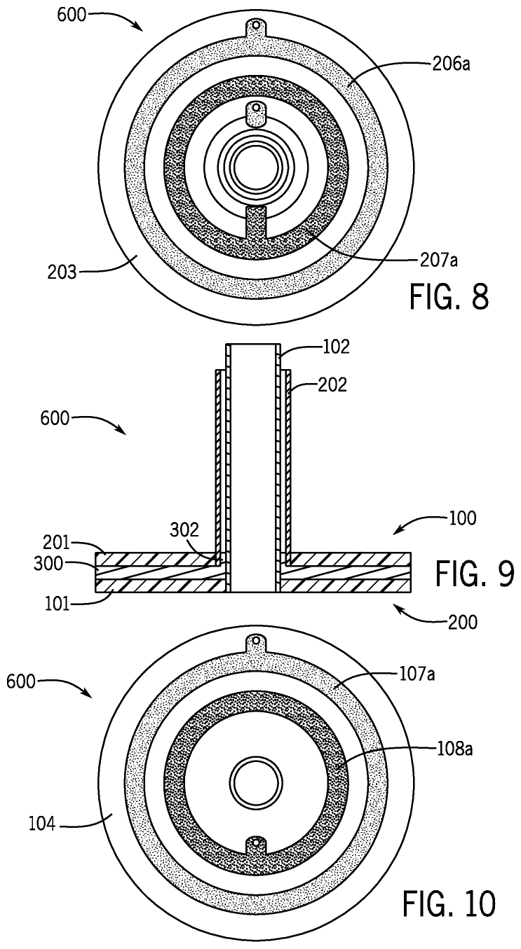

FIG. 7 illustrates the example assembly 600 of pinion component 100 and pinion component 200 with cylinder 102 inserted in coaxial alignment with cylinder 202. Assembly 600 is further illustrated in FIGS. 8, 9 and 10. FIG. 8 is a top view of assembly 600, FIG. 9 is a cross-sectional view of assembly 600 (through section IX-IX of FIG. 8), and FIG. 10 is a bottom view of assembly 600. As shown in FIG. 8, conductive rings 206a and 207a are accessible on the top surface of assembly 600, which in this example is surface 203 of the second example pinion 201. As shown in FIG. 10, conductive rings 107a and 108a are accessible on the bottom surface of assembly 600, which in this example is surface 104 of pinion 101.

As illustrated in FIG. 9, assembly 600 may also include the spacer component 300 between pinion component 100 and pinion component 200. In one example, spacer component 300 may be in the form of a platter with a raised inner lip 302, where the platter serves to separate pinion 101 from pinion 201, and the raised lip 302 serves to maintain cylinders 102 and 202 in coaxial alignment. In one example, spacer component 300 may be fabricated from a non-conductive material with low sliding friction, such as Teflon or the like. It will be appreciated that the example configuration of assembly 600 provides for the electrical and mechanical isolation of pinion components 100 and 200, which are free to rotate independently.

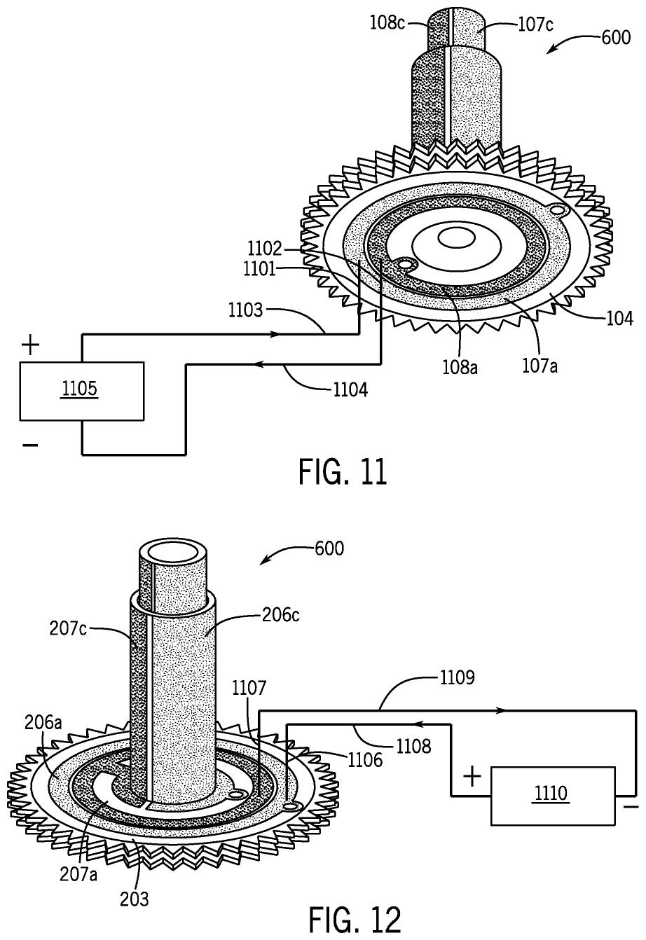

Turning now to FIGS. 11 and 12, there is illustrated a mechanism for providing electrical power and or signals to pinion component 100 and pinion component 200 while they are rotating, as they might be in a timepiece movement for example.

As illustrated in FIG. 11, which shows a bottom perspective view of assembly 600, a sliding electrical contact 1101 may be in contact with ring 107a and another sliding electrical contact 1102 may be in contact with ring 108a. In one example, contacts 1101 and 1102 may be spring contacts on a printed circuit board (not shown) juxtaposed to surface 104 of pinion 101. In one example, contacts 1101 and 1102 may be connected by conductors 1103 and 1104, respectively, to opposite polarities of a power source 1105, such as a battery for example. The electrical potential of the power source thereby being communicated to the surface portions 107c and 108c of cylinder 102 by way of the conductive paths described above. In other examples, the power source may be replaced by a different component, such as a controller for example, where the conductive paths are used for the transmission of data or control signals.

As illustrated in FIG. 12, which shows a top perspective view of assembly 600, a sliding electrical contact 1106 may be in contact with ring 206a and another sliding electrical contact 1107 may be in contact with ring 207a. In one example, contacts 1106 and 1107 may be spring contacts on a printed circuit board (not shown) juxtaposed to surface 203 of pinion 201. In one example, contacts 1106 and 1107 may be connected by conductors 1108 and 1109, respectively, to opposite polarities of a power source 1110, such as a battery for example. The electrical potential of the power source thereby being communicated to the surface portions 206c and 207c of cylinder 202 by way of the conductive paths described above. In other examples, the power source may be replaced by a different component, such as a controller for example, where the conductive paths are used for the transmission of data or control signals.

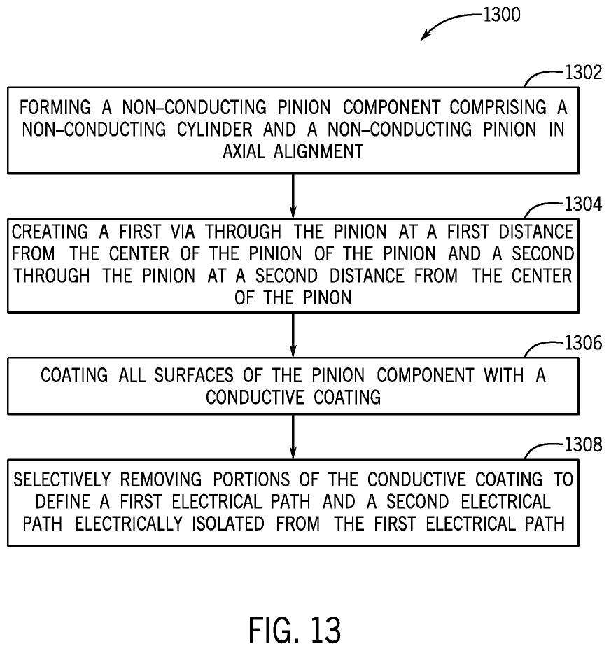

Turning now to FIG. 13, there is flowchart for a process 1300 for manufacturing a pinion component with electrically isolated paths, such as pinion component 100 described above. Process 1300 begins with operation 1302, forming a non-conducting pinion component (100) comprising a non-conducting cylinder and a non-conducting pinion in axial alignment. Process 1300 continues at operation 1304, creating a first via (e.g., 105) through the pinion at a first distance from the center of the pinion and a second via (e.g., 106) through the pinion at a second distance from the center of the pinion. Process 1300 then continues at operation 1306, coating all surfaces of the pinion component with a conductive coating. Process 1300 concludes with operation 1308, selectively removing the conductive coating to define a first electrical path (e.g., 107a, 107b, 107c) and a second electrical path (e.g., 108a, 108b, 108c) electrically isolated from the first electrical path.

Thus, in accordance with various examples described herein, pinion components with isolated electrical paths may be used to facilitate the transmission of power, data or other signals to/from electrical components mounted on the hands of a timepiece.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. An apparatus, comprising:
a first pinion component comprising a first pinion and a first cylinder centered therein, the first cylinder extending from a first surface of the first pinion, the first pinion having a first via and a second via;
a first electrical path extending from a second surface of the first pinion, through the first via to the first surface of the first pinion, and further to a first surface portion of the first cylinder;
a second electrical path extending from the second surface of the first pinion, through the second via to the first surface of the first pinion, and further to a second surface portion of the first cylinder, wherein the second electrical path is electrically isolated from the first electrical path.

2. The apparatus of claim 1, wherein the first electrical path comprises a first ring on the second surface of the first pinion and the second electrical path comprises a second ring on the second surface of the first pinion, wherein the first ring and the second ring are concentric.

3. The apparatus of claim 2, further comprising:
a flat and elongated pinion having an annular end portion, the annular end portion fixedly disposed around a circumference of the first cylinder;
an electrical component attached to a planar surface of the pinion;
a first conductive path from the first surface portion of the first cylinder to a first contact of the electrical component; and
a second conductive path from the second surface portion of the first cylinder to a second contact of the electrical component.

4. The apparatus of claim 3, further comprising:
a first electrical contact in sliding contact with the first ring; and
a second electrical contact in sliding contact with the second ring, wherein the first electrical contact is configured to maintain contact with the first ring when the first pinion rotates and the second electrical contact is configured to maintain contact with the second ring when the first pinion rotates.

5. The apparatus of claim 4, wherein the first electrical contact is connected to a first polarity of a power source and the second electrical contact is connected to a second polarity of the power source, wherein the first electrical path is configured to provide an electrical potential of the first polarity to the electrical component and the second electrical path is configured to provide an electrical potential of the second polarity to the electrical component.

6. The apparatus of claim 4, wherein the first electrical contact is connected to a first terminal of a controller and the second electrical contact is connected to a second terminal of the controller, wherein the first electrical path and the second electrical path comprise one of a data line connection to the electrical component and a control line connection to the electrical component.

7. The apparatus of claim 1, further comprising:
a second pinion component comprising a second pinion and a second cylinder centered therein, the second cylinder extending from a first surface of the second pinion, the second pinion having a third via and a fourth via;
a third electrical path extending from the first surface of the second pinion, through the third via to a second surface of the pinion, to and through the fourth via to the first surface of the second pinion, and further to a first surface portion of the second cylinder;
a fourth electrical path extending from the first surface of the second pinion, connected with a second surface portion of the second cylinder, wherein the second electrical path is electrically isolated from the first electrical path.

8. The apparatus of claim 7, wherein the third electrical path comprises a third ring on the first surface of the second pinion and the fourth electrical path comprises a fourth ring on the first surface of the second pinion, wherein the third ring and the fourth ring are concentric.

9. The apparatus of claim 8, further comprising:
a third electrical contact in sliding contact with the third ring; and
a fourth electrical contact in sliding contact with the fourth ring, wherein the third electrical contact is configured to maintain contact with the third ring when the second pinion rotates and the fourth electrical contact is configured to maintain contact with the fourth ring when the second pinion rotates.

10. The apparatus of claim 7, wherein the second cylinder has an inner diameter greater than an outer diameter of the first cylinder, the first cylinder disposed within and coaxially aligned with the second cylinder, wherein the first surface of the first pinion is opposed to the second surface of the second pinion.

11. The apparatus of claim 10, further comprising an insulating spacer disposed between the first pinion and the second pinion, the spacer configured to provide electrical and mechanical isolation between the first pinion and the second pinion and between the first cylinder and the second cylinder.

12. An apparatus, comprising:
a first pinion component comprising a first pinion with a first surface and a second surface, and a first cylinder extending from the first surface of the first pinion;
a second pinion component comprising a second pinion with a third surface and a fourth surface, and a second cylinder extending from the third surface of the second pinion, the second cylinder extending through the first cylinder of the first pinion component;
a non-conductive spacer positioned between the second surface of first pinion and the third surface of the second pinion,
wherein the first pinion component includes a first conductive path extending from the first surface of the first pinion to the first cylinder, the first pinion component further including a second conductive path extending from the first surface of the first pinion to the first cylinder, the first conductive path being isolated from the second conductive path, and
wherein the second pinion component includes a third conductive path extending from the fourth surface of the second pinion to the second cylinder, the second pinion component further including a fourth conductive path extending from the fourth surface of the first pinion to the second cylinder, the third conductive path being isolated from the fourth conductive path.

13. A method, comprising:
forming a non-conducting pinion component comprising a non-conducting cylinder and a non-conducting pinion in axial alignment;
creating a first via through the pinion at a first distance from the center of the pinion and a second via through the pinion at a second distance from the center of the pinion;
coating all surfaces of the pinion component with a conductive coating; and
selectively removing the conductive coating to define a first electrical path and a second electrical path electrically isolated from the first electrical path.

14. The method of claim 13,
wherein the first electrical path comprises a first ring on a first surface of the pinion connected to the first via, a path through the first via, and a first conductive path on a second surface of the pinion from the first via to a first surface portion of the cylinder; and
wherein the second electrical path comprises a second ring on the first surface of the pinion connected to the second via, a path through the second via, and a second conductive path on a second surface of the pinion from the second via to a second surface portion of the cylinder.

15. The method of claim 14, further comprising:
providing a first electrical contact in sliding contact with the first ring and a second electrical contact in sliding contact with the second ring, wherein one of a power connection, a data line connection and a control line connection is provided to the first electrical path and the second electrical path.
